(19) United States
(12) Patent Application Publication
(10) Pub. No.: US 2005/0060082 A1
(43) Pub. Date: Mar. 17, 2005

(54) Method and system for predicting lateral acceleration of a vehicle

(76) Inventors: Bernd Heuer, Nordstemmen (DE); Torsten Franke, Burgdorf (DE)

Correspondence Address: Kramer Levin Naftalis & Frankel LLP, 919 Third Avenue, New York, NY, 10022, US

(21) Appl. No.: 10/916,769

(22) Filed: Aug. 12, 2004

(30) Foreign Application Priority Data
Aug. 23, 2003 (DE) 103 38 879.6

(51) Int. Cl. G06F 17/00

(52) U.S. Cl. 701/70; 340/440

(57) ABSTRACT

The present invention provides a method and system for predicting the lateral acceleration of a vehicle, especially a commercial vehicle train. The expected lateral acceleration is used to prevent vehicle rollover during critical driving situations. The expected lateral acceleration is calculated in advance using the vehicle's steering angle and speed, or obtained from a lookup table containing predefined combinations of steering angles and speeds corresponding to lateral acceleration values. The expected lateral acceleration is used in the place of, or in addition to, measured instantaneous lateral acceleration to realize a lead time in which early braking of the vehicle by an electronic stability control system or a rollover stability control system is effected, compared to regulation based on measured lateral acceleration alone.

### BACKGROUND OF THE INVENTION

The present invention is generally directed to a method and system for predicting the lateral acceleration of a vehicle.

Modern road vehicles, including commercial vehicles in particular, are increasingly equipped with electronic brake systems (EBSs). In such vehicles, signal transmission from the brake pedal to the EBS electronics takes place via an electric connecting line. Admission of fluid to the brake cylinders takes place via solenoid valves connected upstream. In this way the brake pressure can be increased, held steady or decreased. The solenoid valves are actuated electrically by the EBS electronics.

In contrast to a conventional mechanical brake system, the brakes of a vehicle equipped with an EBS can be acted on by brake fluid, and thus the vehicle can be braked independently of the driver. This capability is exploited by various systems which can be integrated into the EBS. Examples of such systems include distance control or adaptive cruise control (ACC) systems, anti-lock braking systems (ABSs), anti-slip regulation (ASR) systems, electronic stability control (ESC) systems and rollover prevention or rollover stability control (RSC) systems.

Rollover prevention systems that can be integrated in vehicle stability control systems protect against vehicle rollover during tricky driving situations. Negotiating a curve at high speed or changing lanes abruptly in an overtaking maneuver are examples of such situations. The rollover-prevention function gives the driver early warning by means of a signaling device, and if necessary also slows and thus stabilizes the vehicle by acting on all or individual wheel brakes.

In a conventional method for prevention of vehicle rollover of the type described in DE 199 58 221 A1, for example, a critical lateral acceleration or acceleration limit is pre-defined for a vehicle. During driving, the instantaneous lateral acceleration is then constantly determined by means of a lateral acceleration sensor or from wheel-speed sensors and compared with the acceleration limit. As soon as the acceleration reaches approximately 75% of the acceleration limit, the driver is warned, and if necessary, the driving speed is also reduced by automatic throttling of the engine or by automatic braking.

DE 42 40 557 C2 describes a vehicle safety system that includes a steering-angle detector, a speed detector and a lateral acceleration detector. By reference to the measured values of vehicle speed and lateral acceleration, a safe range and a danger range are obtained from a pre-defined table. If the vehicle goes from the safe range into the danger range, a device that reduces vehicle speed is activated. In this case, the measured lateral acceleration used in the conventional method is checked against a simultaneously calculated lateral acceleration, which is obtained from values of the speed detector and of the steering-angle detector. Only when the check is successful is it determined on the basis of a table if a transition into the danger range has taken place. If this transition into the danger range is recognized, a warning is given to the driver or braking is applied.

It is essential that the rollover-prevention systems act, or in other words slow the vehicle, as soon as possible. This quick reaction is necessary to prevent vehicle rollover that has already begun. That is, if a critical value of lateral acceleration is present it must be processed and recognized in the ESC electronics as early as possible.

It is desired to provide a method and system for recognizing a critical lateral acceleration of a vehicle, especially a commercial vehicle, as early as possible.

### SUMMARY OF THE INVENTION

Generally speaking, in accordance with the present invention, an improved method and system for predicting lateral acceleration of a vehicle are provided.

At high driving speed and during dynamic steering movement by the driver, lateral acceleration sufficient to create a vehicle rollover danger can develop very rapidly. Thus, the RSC function has only limited time to slow the vehicle's speed by braking to the point that the rollover danger no longer exists.

According to the present invention, a predicted lateral acceleration that will probably occur is used as a guide variable to detect dangerous rollover conditions instead of the actual instantaneous lateral acceleration, thereby achieving an advantageous time gain. Thus, more time is available to the RSC function for reducing the vehicle speed.

According to the present invention, a value representing the vehicle's expected future lateral acceleration, preceding the actual lateral acceleration measured with a lateral acceleration sensor installed in the vehicle, can be determined from steering angle and vehicle speed values. This is particularly true in cases in which, as is common in commercial vehicles, especially articulated trains, the lateral acceleration sensor is disposed relatively far to the rear, namely in the region of the laden center of gravity. For example, in the method described in DE 199 58 221 A1, the lateral acceleration sensor is mounted directly in front of the rear axle.

By virtue of the present invention, a decisive lead time of as much as several hundred milliseconds can be achieved in which a vehicle stability system can react to prevent an imminent vehicle rollover (compared to a vehicle stability system relying on only measured lateral acceleration). Thus, the present invention enables an ESC system to avoid waiting until a critical value of the vehicle's lateral acceleration actually exists (as measured by the lateral acceleration sensor) and to react directly to the driver's steering movements and thus anticipate (using further variables) a lateral acceleration that threatens to become too great. Because of the time gained in this way for application of the brakes by the ESC system, the vehicle can still be protected against rollover in many cases. The number of critical driving situations can therefore be reduced.

Accordingly, it is an object of the present invention to provide an improved method and system for determining an expected vehicle lateral acceleration that can be used for early braking of the vehicle compared to vehicle braking based on only measured lateral acceleration.

Still other objects and advantages of the present invention will in part be obvious and will in part be apparent from the specification.

The present invention accordingly comprises the various steps and the relation of one or more of such steps with respect to each of the others, and embodies features of construction, combinations of elements, and arrangement of parts which are adapted to effect such steps, all as exemplified in the following detailed disclosure, and the scope of the invention will be indicated in the claims.

### BRIEF DESCRIPTION OF THE DRAWINGS

For a fuller understanding of the invention, reference is had to the following description taken in connection with the accompanying drawings in which:

FIG. 1 is a schematic overhead view of a conventional commercial vehicle (articulated train); and

FIG. 2 is a graph showing, in accordance with a preferred embodiment of the present invention, the variation of steering angle and lateral acceleration (measured and expected) for a lane-changing maneuver of an articulated train at constant vehicle speed.

### DETAILED DESCRIPTION OF THE PREFERRED EMBODIMENTS

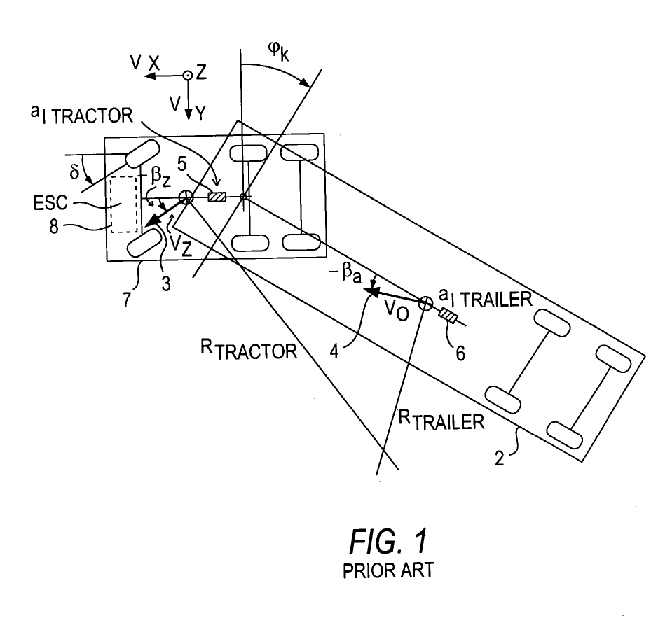

Referring now to the drawing figures, FIG. 1 is an overhead view of an articulated train negotiating a left-hand curve. The vehicle tractor is denoted by reference number 1, and the semitrailer by reference number 2. The center of gravity of tractor 1 is moving with a speed v_{z} in the direction of arrow 3. The center of gravity of semitrailer 2 is moving with a speed vₐ in the direction of arrow 4.

Arrows 3, 4 extend from the center of gravity of the tractor 1 and semitrailer 2, respectively, and do not coincide with the longitudinal axes of the two vehicle train parts. It follows from this alignment that the vehicle as illustrated is negotiating a curve.

The side-slip angle of tractor 1, or in other words the deviation of its actual direction of movement from its longitudinal axis, is −βz. The corresponding slide-slip angle of the semitrailer is −βa. Here, the minus signs indicate that the vehicle is negotiating a left-hand curve.

The steering angle of the tractor is denoted by δ. This is the angle by which the front wheels of the tractor deviate from the straight-ahead position.

The angle between tractor 1 and semitrailer 2 is φk.

The radius of motion of the center of gravity of tractor 1 is R_{tractor} and correspondingly the radius of motion of the center of gravity of semitrailer 2 is Rₜᵣₐᵢₗₑᵣ. The latter is smaller than the traveled radius of the tractor 1.

For measuring the actual lateral accelerations of tractor 1 and semitrailer 2, a first lateral acceleration sensor 5 is provided for measurement of the lateral acceleration a_{l tractor} of the tractor and a second lateral acceleration sensor 6 is provided for measurement of the lateral acceleration a_{l trailer} of the semitrailer. Both lateral acceleration sensors 5, 6 are located approximately at the center of gravity of the respective vehicle parts 1, 2.

For cost reasons, the acceleration sensor 5 of the semitrailer 2 can be omitted.

The vehicle speeds at the center of gravity of the tractor 1 are denoted by vₓ and v_{y}. The value vₓ corresponds to the longitudinal direction and the value v_{y} to the transverse direction of the tractor 1.

The vehicle's motion variables discussed above and shown in FIG. 1 are used in their entirety or in part in an ESC 8 installed in the tractor 1. In addition to the measured values of lateral acceleration sensor 5, a conventional ESC system typically uses further sensors to measure the speeds of revolution of the wheels as well a steering-angle sensor and a yaw-rate sensor for the tractor. Such sensors are not illustrated in FIG. 1, but are known to those skilled in the art.

The acceleration values of the two vehicle train parts 1, 2 can be calculated from the values of the wheel sensors in a conventional manner, and separate sensors are not needed to measure the longitudinal acceleration of the vehicle.

Within the ESC system, the motion variables discussed above are used by system software to describe an internal vehicle model. Thus, the ESC system always models the instantaneous driving condition of, for example, a skidding vehicle. By means of appropriate logic in the ESC system, an attempt can then be made to restabilize the vehicle by braking individual wheels in conventional manner.

According to the present invention, a predictive, expected value a_{l expected} of the vehicle's lateral acceleration can be determined from components of the foregoing motion variables. At least the variables for steering angle and for vehicle speed are used in the calculation. According to the present invention, the advance calculation can be carried out advantageously using the following formula:
a_{l expected}=δₓv_{z}/(EGₓv_{z}+R_{tractorwheelbase}/v_{z})

in which:
δ=steering angle of the vehicle,
v_{z}=speed of center of gravity of the articulated train tractor,
EG=roll-steer effect of the vehicle, and
R_{tractorwheelbase}=wheel base of the articulated train tractor.

As evident from testing, the calculated expected lateral acceleration based on the steering angle in conjunction with the vehicle speed cannot be measured immediately. This is because of the inertia of the vehicle, especially of the tractor 1. Instead, the more dynamic the steering movements are, the greater the time difference between the expected lateral acceleration and the measured lateral acceleration.

As previously discussed, the time difference can be as long as several hundred milliseconds. For many dynamic driving maneuvers, this time gain creates the only opportunity to protect the vehicle against rollover. This is particularly true for articulated trains, since it is not possible with the sensor systems that are typically provided to make an exact prediction of the height of the centers of gravity of the tractor and semitrailer. This height can vary depending on the load. Experience has shown that the time interval between the instant that the threshold for control action by the ESC system is reached and the instant at which the vehicle's lateral acceleration leads to rollover can be very short in the case of a high center of gravity.

Regarding the variables included in the above formula, the steering angle of the articulated train tractor is measured with a standard steering-angle sensor.

The speed of the center of gravity of the articulated train tractor 1 is calculated from its wheel speeds, while the steering angle is also taken into consideration.

The roll-steer effect of the vehicle is calculated by the electronics of the ESC system. The basis for this calculation is the following known formula for the yaw rate of the vehicle:
ψ=δ/(EGₓv_{z}+R_{tractorwheelbase}/v_{z})

where:
ψ=yaw rate, measured with the yaw-rate sensor of the ESC system,
δ=steering angle,
EG=roll-steer effect,
v_{z}=vehicle speed, and
R_{tractorwheelbase}=wheel base of the articulated train tractor

The wheel base of the articulated train tractor 1 is known and is parameterized in the ESC 8 electronics.

By rearranging the above equation to solve for EG, the desired roll-steer effect is determined. This value, which is typical for the vehicle, is determined within defined boundary conditions, specifically at a definite speed and a definite lateral acceleration during stable driving.

The inventive prediction of lateral acceleration applies only in the precise situation where the coefficient of friction of the roadway being traveled permits. Therefore, the variation of the actual lateral acceleration of the articulated train tractor 1 as measured by sensor 5 is expediently evaluated during a steering movement and used as a component in correcting the expected lateral acceleration. If an RSC braking reaction initiated in response to the expected lateral acceleration proves on the basis of the measured lateral acceleration to be superfluous or too great, it will be canceled or reduced.

Furthermore, the instantaneous states of the vehicle model within the ESC system can also be used advantageously for lateral acceleration checking purposes. For example, if the vehicle appears to be unstable, or in other words in a condition in which the vehicle is understeered or oversteered, the expected lateral acceleration presumably cannot develop, because the coefficient of friction of the roadway is too low. In this case, a software correction by which the expected lateral acceleration is reduced is then made in advance. This plausibility check, which is based on the measured values of the lateral acceleration sensor and of the state of the vehicle model within the ESC system, runs continuously in the background. The measured values of the steering-angle sensor and of a yaw-rate sensor that is typically standard in an ESC system are also used for the plausibility check.

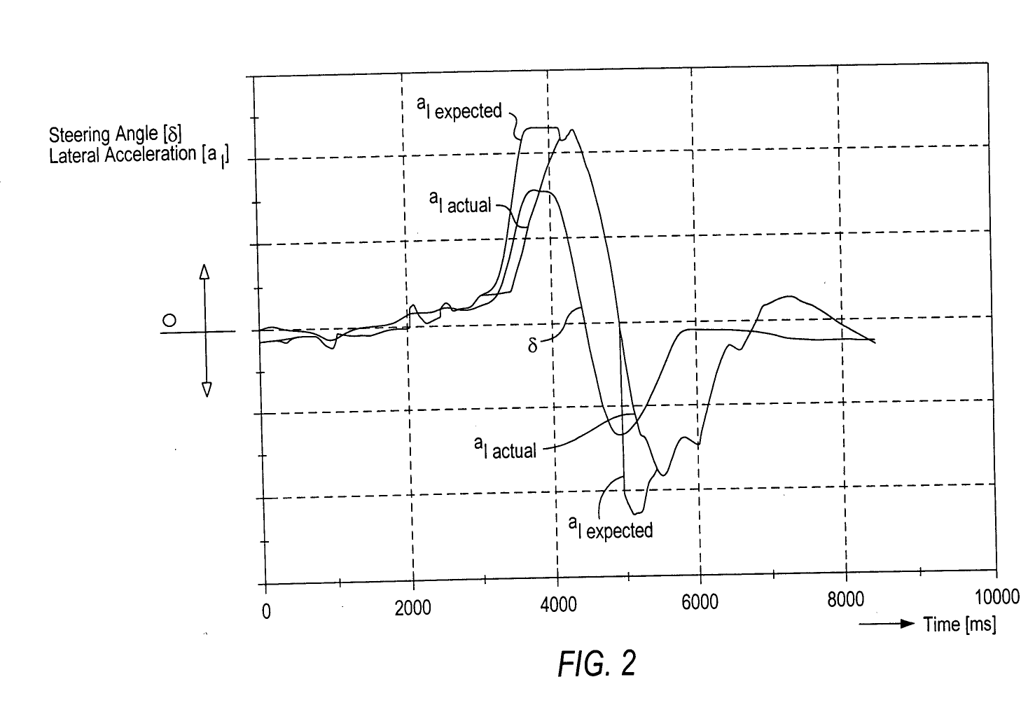

Referring now to FIG. 2, the variation of steering angle δ and lateral acceleration aₗ (both measured and expected) are plotted against time for a change-of-lane maneuver of an articulated train moving at a constant speed.

At the beginning of the driving maneuver, all values are approximately zero. That is, the vehicle is traveling straight ahead on the right lane of a road. After about 2 seconds, the driver begins to change lanes to the left. In connection with this maneuver, the front wheels reach their maximum deflection (maximum steering angle δ) after about 4 seconds.

At that instant, the calculated expected lateral acceleration a_{l expected} reaches its maximum. In contrast, the maximum actual, measured, instantaneous lateral acceleration a_{l actual} of the vehicle is shifted from a_{l expected}, or in other words delayed, by approximately 200 milliseconds. Since the expected lateral acceleration has been actually established, no vehicle instability due to a smooth roadway occurs.

The roll-steer effect EG of the vehicle is a component of the expected lateral acceleration a_{l expected}. This variable is only approximately determined by the ECU of the ESC system. Thereby, inaccuracies propagate directly to the expected lateral acceleration. This is the reason why the value of a_{l expected} in FIG. 2 is higher than the measured a_{l actual}.

After about 4.5 seconds, the steering angle δ returns to zero. This means that the vehicle is now positioned in the left lane. The driver then steers the vehicle immediately back into the right lane. After about 5 seconds, the steering angle δ reaches its maximum toward the right. In this case, the expected lateral acceleration is delayed by about 100 milliseconds relative to the maximum point of the steering angle. The actual lateral acceleration is delayed by approximately an additional 100 milliseconds. Thus, a window of 100 milliseconds exists for action by the RSC system between the expected lateral acceleration and the actual lateral acceleration.

After about 7 seconds, all three values have returned to zero, meaning that the vehicle is once again traveling straight ahead on the right side of the road.

As is evident from FIG. 2, a considerable window of time for a possible braking reaction by an ESC system can be achieved, as described in the foregoing, by using the expected lateral acceleration of the vehicle. Thus, a considerable increase in safety is realized for the driver and the vehicle.

In an advantageous alternative embodiment of the present invention, an expected lateral acceleration can also be determined by looking to a pre-determined table which includes an expected lateral acceleration corresponding to and for all combinations of values of steering angle and vehicle speed. This table is generated based on information learned from driving tests. An expected lateral acceleration value from the table also precedes the actual lateral acceleration, and can be used advantageously in an ESC or RSC system, as described hereinabove.

Accordingly, the present invention provides a method and system for obtaining an expected lateral acceleration value for a vehicle in advance of the measurement of actual lateral acceleration. Using the expected lateral acceleration to anticipate vehicle rollover threats provides additional time to take preventative action as compared with systems that monitor only actual instantaneous lateral acceleration.

It will thus be seen that the objects set forth above, among those made apparent from the preceding description, are efficiently attained, and since certain changes may be made in the above constructions without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall there between.

1. In a vehicle having at least one of an electronic stability control system and a rollover stability control system, a method for preventing vehicle rollover comprising the steps of determining at least one variable corresponding to a steering angle of said vehicle and at least one variable corresponding to vehicle speed, calculating an expected lateral acceleration for said vehicle based at least in part on said at least one variable corresponding to the steering angle of said vehicle and on said at least one variable corresponding to vehicle speed, comparing said calculated expected lateral acceleration in lieu of a measured lateral acceleration against a preselected critical lateral acceleration value, and at least one of providing a warning of a vehicle rollover danger and automatically reducing vehicle speed using at least one of said electronic stability control system and said rollover stability control system when said calculated expected lateral acceleration reaches said critical lateral acceleration value.

2. The method of claim 1, wherein said vehicle is an articulated vehicle train including a tractor vehicle train part and said at least one variable corresponding to vehicle speed is the speed of the center of gravity of said tractor vehicle train part.

3. The method of claim 1, wherein said step of calculating an expected lateral acceleration is based on at least one of a wheel base and roll-steer effect of said vehicle.

4. The method of claim 1, further comprising the steps of measuring lateral acceleration of said vehicle during steering of said vehicle, and correcting said expected lateral acceleration based on variation of said measured lateral acceleration.

5. The method of claim 1, wherein said vehicle includes an electronic stability control system, the method further comprising the steps of obtaining signals relating to instability of said vehicle from said electronic stability control system, and using said signals for correction of the expected lateral acceleration.

6. The method of claim 1, wherein said vehicle is an articulated vehicle train including a tractor vehicle train part, and said step of calculating an expected lateral acceleration is effected using the formula a_{l expected}=δₓv_{z}/(EGₓv_{z}+R_{tractorwheelbase}/v_{z})
where:
a_{l expected}=expected lateral acceleration,
δ=steering angle,
EG=vehicle roll-steer effect,
v_{z}=speed of center of gravity of tractor vehicle train part, and
R_{tractorwheelbase}=wheel base of tractor vehicle train part.

7. A method for predicting lateral acceleration of a vehicle having at least one of an electronic stability control system and a rollover stability control system constructed and arranged to at least one of provide a warning of a vehicle rollover danger and automatically reduce vehicle speed when a critical lateral acceleration is reached, the method comprising the steps of determining at least one variable corresponding to a steering angle of said vehicle and at least one variable corresponding to vehicle speed, comparing said at least one steering angle variable and said at least one vehicle speed variable against a lookup table including predefined combinations of steering angle values and vehicle speed values, each of said predefined combinations being associated with a corresponding lateral acceleration value, and assigning as an expected lateral acceleration of said vehicle the lateral acceleration value from said table corresponding to said at least one steering angle variable and said at least one vehicle speed variable.

8. A system for preventing vehicle rollover, comprising means for determining at least one variable corresponding to a steering angle of said vehicle and at least one variable corresponding to vehicle speed, means for calculating an expected lateral acceleration for said vehicle based at least in part on said at least one variable corresponding to the steering angle of said vehicle and on said at least one variable corresponding to vehicle speed, means for comparing said calculated expected lateral acceleration in lieu of a measured lateral acceleration against a preselected critical lateral acceleration value, and means for at least one of providing a warning of a vehicle rollover danger and automatically reducing vehicle speed when said calculated expected lateral acceleration reaches said critical lateral acceleration value.

9. The system of claim 8, wherein said vehicle is an articulated vehicle train including a tractor vehicle train part and said at least one variable corresponding to vehicle speed is the speed of the center of gravity of said tractor vehicle train part.

10. The system of claim 8, wherein said means for calculating an expected lateral acceleration utilizes at least one of a wheel base and roll-steer effect of said vehicle.

11. The system of claim 8, further comprising means for measuring lateral acceleration of said vehicle during steering of said vehicle, and means for correcting said expected lateral acceleration based on variation of said measured lateral acceleration.

12. The system of claim 8, wherein said vehicle includes an electronic stability control system, and further comprising means for obtaining signals relating to instability of said vehicle from said electronic stability control system, and wherein said means for calculating an expected lateral acceleration utilizes said signals.

13. The system of claim 8, wherein said vehicle is an articulated vehicle train including a tractor vehicle train part, and said means for calculating an expected lateral acceleration effects the formula a_{l expected}=δₓv_{z}/(EGₓv_{z}+R_{tractorwheelbase}/v_{z})
where:
a_{l expected}=expected lateral acceleration,
δ=steering angle,
EG=vehicle roll-steer effect,
v_{z}=speed of center of gravity of tractor vehicle train part, and
R_{tractorwheelbase}=wheel base of tractor vehicle train part.

14. A system for predicting lateral acceleration of a vehicle, comprising means for determining at least one variable corresponding to a steering angle of said vehicle and at least one variable corresponding to vehicle speed, a lookup table including predefined combinations of steering angle values and vehicle speed values, each of said predefined combinations being associated with a corresponding lateral acceleration value, means for comparing said at least one steering angle variable and said at least one vehicle speed variable against said lookup table, and means for assigning as an expected lateral acceleration of said vehicle the lateral acceleration value from said table corresponding to said at least one steering angle variable and said at least one vehicle speed variable.
